(19) United States
(12) Patent Application Publication
(10) Pub. No.: US 2026/0185564 A1
(43) Pub. Date: Jul. 2, 2026

(54) SEAL CARTRIDGE WITH BEARING ASSEMBLY AND RELATED METHODS

(71) Applicant: Bal Seal Engineering, LLC, Foothill Ranch, CA (US)

(72) Inventor: Constantijn van de Pas, Amsterdam (NL)

(73) Assignee: Bal Seal Engineering, LLC, Foothill Ranch, CA (US)

(21) Appl. No.: 19/546,534

(22) Filed: Feb. 23, 2026

Related U.S. Application Data
(63) Continuation of application No. PCT/US25/32403, filed on Jun. 5, 2025.
(60) Provisional application No. 63/657,336, filed on Jun. 7, 2024.

(51) Int. Cl. F16C 33/78

(52) U.S. Cl. CPC F16C 33/7886

(57) ABSTRACT

Seal assemblies, bearing assemblies, and gaskets and their components can be used as pre-packaged systems or assemblies inside a can housing. Gaskets or washers to restrict flow and gaskets or washers with memory lips to operate as sealing lips can be included to increase the number of sealing points inside the pre-packaged systems. In a pre-packaged configuration, the cylinder can be a straight cylinder, a stepped cylinder, or a split cylinder. Bearing assemblies can be pre-packaged with the sealing assemblies.

### CROSS-REFERENCE TO RELATED APPLICATION

This is a continuation application of PCT Application No. PCT/US25/32403, filed Jun. 5, 2025, which claims priority from U.S. provisional application Ser. No. 63/657,336, filed Jun. 7, 2024, the contents of which are expressly incorporated herein by reference.

### FIELD OF ART

The present disclosure is generally related to seal cartridges with bearing assemblies with specific discussions on spring energized lip seals located in a can or cartridge with provisions for aligning with bearing assemblies and related methods.

### BACKGROUND

Bearings, such as ball bearings and roller bearings, are known for supporting an element, such as a shaft, which rotates within an outer stationary element, such as a housing. Lip seals, which can have an energizer, are known for providing a seal to the flow path located between a dynamic surface and a stationary surface, such as a shaft and a housing, to prevent liquid flow from a high-pressure region to a relatively lower pressure region.

When an application uses both a seal and a bearing, the two are typically spaced or not connected to one another. Further, the seal and the bearing are typically mounted sequentially, one after the other. When used together, the seal is configured to prevent a fluid, such as oil, from leaking out from the bearing box that contains the bearing and/or process fluid from leaking into the bearing box.

### SUMMARY

Aspects of the invention are directed to a pre-packaged seal system and a pre-packaged seal and bearing system.

In an example, the cartridge seal and bearing system comprises: a can housing having a body having a wall with an interior surface defining a bore having a first end and a second end, the first end having a retaining wall or a retaining disc, and one or more inlet ports formed through the wall for dispensing epoxy glue therethrough; a structural component having a body located in the bore of the can housing, a first seal element comprising an inside flange, an outside flange, and a center channel section located between the inside and outside flanges, the outside flange of the first seal element being pressed against the interior surface of the can housing by the structural component; a second seal element comprising an inside flange, an outside flange, and a center channel section located between the inside and outside flanges, the outside flange of the second seal element being pressed against the interior surface of the can housing by the structural component; a first sealing washer located in the bore between the adjacent the retaining wall or the retaining disc and the first seal element, the first sealing washer having a body with an outside perimeter and an opening with an inside perimeter; a second sealing washer located in the bore and in contact with the center channel section of the second sealing element, the second sealing washer having a body with an outside perimeter and an opening with an inside perimeter; a bearing assembly comprising an inner ring, an outer ring, and a plurality of rolling elements between the inner and outer rings, said bearing assembly located in the bore and closer to the second seal element than the first seal element; and wherein the outer ring is in a loose fit arrangement inside the bore when initially assembled inside the bore and is aligned with the one or more ports.

The cartridge seal and bearing system can further comprise a second retaining wall or retaining disc located between the second sealing washer and the bearing element.

The cartridge seal and bearing system wherein the can housing with the body can have a split line that separates the can housing into a first can housing component and a second can housing component.

The cartridge seal and bearing system wherein the structural component can have a multi-piece body comprising a first structural component section and a second structural component section.

The cartridge seal and bearing system wherein the first structural component has a lip that mechanically engages with a lip on the outside flange of the first sealing element.

The cartridge seal and bearing system wherein the second structural component has a lip that mechanically engages with a lip on the outside flange of the second sealing element.

The cartridge seal and bearing system can further comprise a canted coil spring biasing against the structural component and the inside flange of the first sealing element.

The cartridge seal and bearing system can further comprise a second canted coil spring biasing against the structural component and the inside flange of the second sealing element.

The cartridge seal and bearing system wherein the plurality of rolling elements can be a plurality of spherical balls.

The cartridge seal and bearing system can further comprise epoxy glue in a space between the outer ring and the interior surface of the can housing when in a first state, in which the epoxy glue is flowable.

The cartridge seal and bearing system wherein the epoxy glue has a second state in which the epoxy glue hardens and is not flowable.

The cartridge seal and bearing system wherein the bore of the can housing has a first bore section with a first inside diameter and a second bore section with a second inside diameter, which is larger than the first inside diameter.

The cartridge seal and bearing system wherein the bearing assembly is located in the second bore section.

The cartridge seal and bearing system can further comprise a shaft projecting through the inner ring of the bearing assembly and a bore of the cartridge seal.

The cartridge seal and bearing system wherein the can housing and the shaft are located in an equipment housing.

The equipment housing can be a pump.

The cartridge seal and bearing system wherein the first sealing washer has a memory lip having a curved portion at the opening of the inside perimeter.

The cartridge seal and bearing system wherein both the outside perimeter of the first sealing washer and the outside perimeter of the second sealing washer contact the interior surface of the can housing.

The cartridge seal and bearing system wherein the bore of the can housing has a generally constant inside diameter from the first end to the second end.

The cartridge seal and bearing system wherein the first seal element has an excluder and an annular recess at an end of the inside flange and an end of the center channel section.

The cartridge seal and bearing system wherein the second seal element has an excluder and an annular recess at an end of the inside flange and an end of the center channel section.

The cartridge seal and bearing system wherein the first seal element has a free end and the second seal element has a free end, and wherein the two free ends point at one another.

The cartridge seal and bearing system wherein the structural component has a flange stub, and wherein the flange stub is spaced from the interior surface of the can housing.

The cartridge seal and bearing system further comprising service grease located in a spring cavity defined by the first sealing element.

The cartridge seal and bearing system can further comprise service grease located in a spring cavity defined by the second sealing element.

Aspects of the invention further comprise a method of assembling a pre-packaged cartridge and bearing system comprising: providing a can housing having a body having a wall with an interior surface defining a bore having a first end and a second end, the first end having a retaining wall or a retaining disc, and one or more inlet ports formed through the wall for dispensing epoxy glue therethrough; placing a seal assembly inside the bore, the seal assembly comprising: a structural component having a body located in the bore of the cylinder housing; a first seal element comprising an inside flange, an outside flange, and a center channel section located between the inside and outside flanges, the outside flange of the first seal element being pressed against the interior surface of the can housing by the structural component; a second seal element comprising an inside flange, an outside flange, and a center channel section located between the inside and outside flanges, the outside flange of the second seal element being pressed against the interior surface of the can housing by the structural component; a first sealing washer located in the bore between the adjacent the retaining wall or the retaining disc and the first seal element, the first sealing washer having a body with an outside perimeter and an opening with an inside perimeter; a second sealing washer located in the bore and in contact with the center channel section of the second sealing element, the second sealing washer having a body with an outside perimeter and an opening with an inside perimeter; placing a bearing assembly inside the bore, the bearing assembly comprising an inner ring, an outer ring, and a plurality of rolling elements between the inner and outer rings, said bearing assembly located in the bore and closer to the second seal element than the first seal element; and wherein the outer ring is in a loose fit arrangement inside the bore when initially assembled inside the bore and is aligned with the one or more ports.

The method can further comprise placing a shaft through the inner ring of the bearing assembly and a bore of the seal assembly.

The method can further comprise adding epoxy glue through the one or more ports.

The method can further comprise curing the epoxy glue to fix the outer ring from moving.

The method can further comprise placing the can housing inside a pump.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 is a cross-sectional side view of a seal cartridge having a seal assembly pre-packaged in a can housing or cartridge in accordance with aspects of the invention.

FIG. 2 is a cross-sectional side view of the seal cartridge of FIG. 1 mounted with a bearing assembly and on a shaft in accordance with aspects of the invention.

FIG. 3 is a cross-sectional side view of a seal cartridge mounted with a bearing assembly and on a shaft in accordance with further aspects of the invention.

FIG. 4 is a cross-sectional side view of a seal cartridge having a seal assembly pre-packaged in a can housing or cartridge in accordance with further aspects of the invention.

FIG. 5 is a cross-sectional side view of a seal cartridge having a seal assembly pre-packaged in a can housing or cartridge in accordance with still further aspects of the invention.

FIG. 6 is a cross-sectional side view of a seal cartridge and bearing assembly mounted inside an equipment housing and supported by a second bearing assembly.

FIG. 7 is a cross-sectional side view of another embodiment of a seal cartridge and bearing assembly mounted inside an equipment housing and supported by a second bearing assembly.

FIG. 8 is a cross-sectional side view of yet another embodiment of a seal cartridge and bearing assembly mounted inside an equipment housing and supported by a second bearing assembly.

### DETAILED DESCRIPTION

The detailed description set forth below in connection with the appended drawings is intended as a description of the presently preferred embodiments of lip seals and bearing assemblies provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

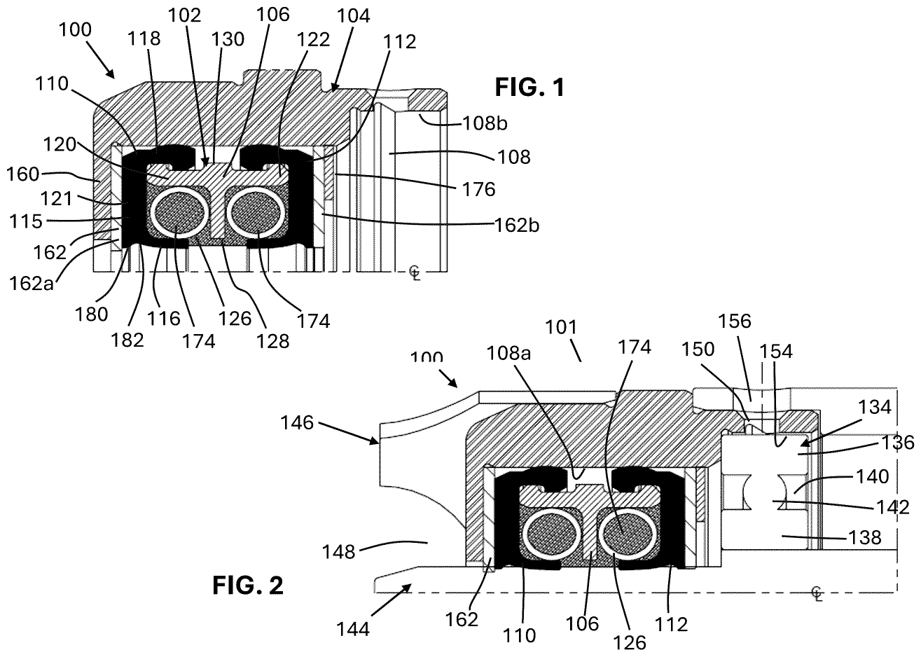

With reference now to FIG. 1, a seal cartridge or seal cartridge assembly 100 comprising a seal assembly 102 is shown located inside a can cylinder or can housing 104, which is also known as a cartridge. The cartridge 104 has a body with an interior surface defining a bore 108 and the seal assembly 102 is mounted inside the bore. The bore has a first end and a second end.

As shown, the seal assembly 102 has a structural component 106 that functions as a core or a base for mounting a first seal element 110 and a second seal element 112. Each seal or sealing element has a body 115 with an inside flange 116, an outside flange 118, and center channel section 121 connected to and located between the inside and outside flanges. The seal assembly 100 is annular and has a bore. The inside flange 116 defines an inside opening and defines at least part of the bore of the seal assembly with an inside diameter for accommodating a shaft in an interference fit around the shaft to seal against the shaft. The outside flange 118 defines an outside diameter for sealing against the interior surface of the bore 108 of the cartridge 104.

The body 115 of the seal element has a cavity defined by the two sealing flanges and the center channel section. As shown the cavity of the first seal element 110 receives a first end 120 of the structural component 106. In an example, the first end 120 mechanically engages the outside flange 118 of the first seal element 110. The first end 120 and the outside flange 118 both have a lip for mechanically engaging one another along the axial direction, to restrict separation parallel to the lengthwise axis of the seal cartridge assembly. The second seal element 112 is similarly configured and receives the second end 122 of the structural component 106.

As shown, the outside sealing flanges 118 of the first and second seal elements 110, 112 are located in the gap between the structural component 106 and the interior surface of the cartridge 104. The structural component is sized and shaped to press the outside flanges against the cartridge to provide a seal therebetween. In an example, the structural component 106 is spaced from the inside diameter of the cartridge 104. In other words, the structural component 106 does not press fit into the bore of the cartridge or can housing 104. Thus, the structural component 106 can float or move in the radial direction, perpendicular to lengthwise axis of the seal cartridge assembly 100, but for the outside flanges of the first and second sealing flanges being pressed against the interior surface.

In an example, an energizer 126 is located in the seal element cavity as shown to bias against the structural component 106 and the inside flange 116. Preferably, an energizer 126 is located in each cavity of each of the two seal elements. Each energizer is configured to bias the inside flange away from the structural component, and away from the outside flange 118. When the cartridge seal 100 is mounted onto a shaft, the biasing of the inside flange by the energizer has the effect of pressing the inside flange against the shaft to provide a positive sealing pressure against the shaft. In some examples, the seal cartridge is practiced without any energizer and relies solely on the elastic properties of the seal elements, which may be made from an elastomer, a thermoplastic elastomer, or an engineered plastic. In some examples, the energizer is a canted coil spring (CCS). In other examples, the energizer can be an O-ring, a CCS embedded inside an O-ring, a V-spring, or a ribbon spring, all in an annular spring ring configuration. Canted coil springs have interconnected coils, and wherein the coils are all canted generally in the same direction. Canted coil springs can bias in the radial direction, radial to the spring coil centerline, to bias two structures or components away from one another.

An inner flange extension 128 extends radially inwardly from the interior surface of the structural component 106 and extends toward the center of the structural component, but sized so that there is no contact with the shaft when the seal cartridge is mounted onto the shaft. The inner flange extension 128 divides the interior of the structural component into a first section to the left and a second section to the right of the inner flange extension. The inner flange extension 128 helps to retain the respective energizer 126 in the respective spring cavities defined by the first end 120 and the first sealing element cavity and the second end 122 and the second sealing element cavity.

The outer surface of the structural component 106, outwardly of the interior surface, has a flange stub 130. The flange stub extends radially outwardly above the exterior surface of the structural component but is spaced from the interior surface of the cartridge 104. The flange stub 130 can be incorporated to add girth or bulk to the body of the structural component, which can be made from a metal material or a metal composite material. Alternatively, the exterior surface can be generally planar and practiced without the flange stub. Because the flange stub 130 does not contact the interior surface of the cartridge, the structural component 106 is not directly constrained by the cartridge and can float. This configuration is useful during assembly in that the structural component can slide into the bore 108 from the open end of the can housing 104 into position, without interference between the structural component and the housing as the structural components is repositioned within the bore. As shown, the structural component, without physical contact with the bore of the housing, can shift up and down and can pitch due to movement of the shaft, such as during operation, or simply due to mis-alignment of the shaft relative to the seal cartridge when the shaft is inserted into the bore of the seal cartridge. In some examples, the height of the flange stub 130 can vary but still does not contact the inside surface of the bore. In other examples, the flange stub 130 is eliminated and the exterior of the structural component between the two end can be generally constant.

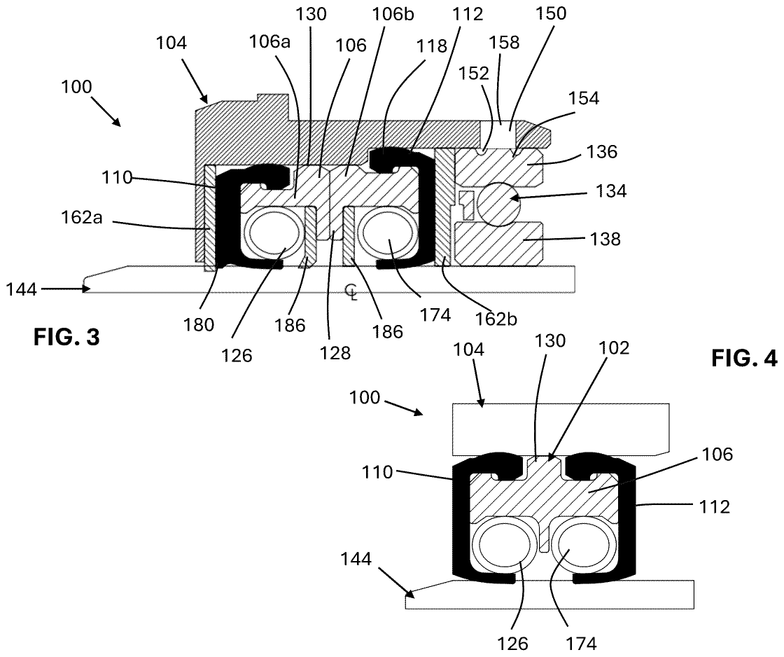

With reference now to FIG. 2 in addition to FIG. 1, the seal cartridge 100 is shown with a bearing assembly 134 and a shaft 144. The seal cartridge 100 and the bearing assembly 134 may be referred to as a SCB assembly 101. In an example, the bearing assembly 134 comprises an outer ring 136, an inner ring 138, and a cage 140 for retaining a plurality of rolling elements 142 (only one shown) in retaining sockets. The various components of the bearing assembly 134 are typically made from a metal material, which can all be the same metal material or more likely from a variety of different metal materials. The inner ring 138 is configured to tightly fit around the exterior of the shaft 146 and rotate with the shaft along with the rolling elements 142, which are held by the cage 140 as they rotate with the shaft. The inner ring 138 can have an inside diameter configured to fit around the shaft in an interference fit and an outer diameter, relative to the inside diameter, defining a thickness therebetween. The inner ring 138 also has a width and is sized and shaped to accommodate selected rolling elements. As shown, the shaft 144 is provided with a shoulder at the interface between a first diameter section and a second diameter section. The seal assembly can be mounted at the smaller first diameter section while the bearing assembly can be mounted at the larger second diameter section. However, the shaft can have a generally constant single diameter, not including the tapered nose section of the shaft, as shown in FIG. 3.

In the present embodiment, the cartridge 104 has a bore 108 with a first bore section 108a and a second bore section 108b, which has a larger inside diameter than the first bore section. However, the second bore section and the first bore section can be practiced with other configurations, such as one where both have the same inside diameter or a generally constant inside diameter. In a known manner, the outer ring 136 is normally tightly fitted against the interior surface of the cartridge and is held stationary to the interior surface of the can housing while the inner ring 138 and the rolling elements 142 rotate with the shaft 144. The outer ring 136 can have an inside diameter configured to contact the rolling elements 142 and an outer diameter normally configured to fit against the interior of the cylinder cartridge in an interference fit. The inside diameter and the outside diameter of the outer ring 136 define a thickness therebetween. The outer ring 136 has a width and is sized and shaped to accommodate selected rolling element types.

However, in accordance with aspects of the present invention, the outside diameter of the outer ring 136 is loosely fitted at the second bore section 108b, without an interference fit. In an example, there can be a clearance of about 2 thousandths to about 40 thousandths of an inch on each side of the diameter, or a total clearance of about 4 thousandths to about 80 thousandths of an inch. Preferably, the clearance is sized to the capillary function of the glue used to secure the outer ring 136 in place and the ability of the outer ring to adjust for alignment, before the glue is introduced, as further discussed below. The clearance at the interface between the outer ring 136 and the bore 108b allows play in the assembly and allows the outer ring 136 to move within the second bore section 108b to adjust for alignment. For example, when both the shaft and the bearing assembly are assembled with the cartridge seal, both the seal elements and the bearing assembly having the shaft extending therethrough or therebetween can adjust to find an equilibrium with the lowest internal distortion or misalignment. In this relaxed, low strain, position, concentricity of rotation of the shaft is at its most optimum. Thereafter, the loose fitting arrangement of the outer ring 136 can be secured in place, such as by using glue, so as to set the final rotation of the shaft at its most optimum position.

Aspects of the invention therefore include provisions for fixing the alignment of the components within the bore of the housing while being mounted on a shaft after the components are allowed to settle to their lowest combined misalignment following assembly with the shaft. Thus, when the shaft rotates during service, the magnitude of the misalignment is reduced by allowing the outer ring 136 to settle to its lowest combined misalignment position relative to the seal assembly 102 and the shaft before securing the outer ring 136 from movement, such as by introducing glue, epoxy, adhesive, or bonding material to secure the outer ring from moving relative to the housing 104. Unless the context indicates otherwise, glue, adhesive, epoxy, adhesive, and bonding materials are flowable when first introduced and then hardened over time, such as with heat, and therefore are considered synonymous terms. An additional aspect of the invention is a method for aligning components inside a seal cartridge or inside an equipment housing having a seal cartridge, the method comprising introducing glue in its first flowable state and then allowing the glue to harden and not flowable in its second state inside the cartridge housing. The glue can be introduced to take up the loose fitting of the bearing assembly, such as between the outer ring and the can housing or the equipment housing or between the inner ring and the shaft.

Thus, any misalignment that can normally occur for similar configurations when the cartridge is assembled onto the shaft with bearings inside a rigid outside body like a test fixture, a can housing, a cage or a motor, etc. can be mitigated in accordance with aspects of the invention. The sealing elements of the seal assembly are the most flexible component in the mostly metal system shown in FIG. 2. When all components have tight fittings then these fittings force the shaft out of center in the cartridge in the amount of the tolerance stack up. The misalignment will end up in the position of the shaft inside the cartridge because of the flexible nature of the sealing elements in the cartridge. Thus, when a misaligned shaft rotates, the seal wear of the seal elements is not evenly distributed for each rotation of the shaft and one side will be over-compressed while the other side will leak faster than a properly centered or aligned shaft. Thus, by introducing a play between the bearing assembly and the cartridge housing or equipment housing, the components are allowed to settle to their lowest constraint, which leads to a more aligned system. The play at the bearing can then be taken up to fix the alignment for service. In alternative examples, the play can be introduced between the bearing assembly and the shaft, at the inner ring of the bearing assembly, as further discussed below.

The SCB assembly 101 is shown mounted in an equipment housing 146, such as a pump, which is partially shown. The seal cartridge 100 is configured to seal the bearing assembly 134 from the fluid chamber 148 of the pump to prevent or restrict fluid from the fluid chamber from flowing into the bearing assembly. The bearing assembly 134 is configured to support the shaft 144 and the impeller (not shown) mounted thereon during operation, where the shaft rotates with the impeller to convert rotational velocity into fluid pressure as the fluid exits the pump.

Thus, to improve alignment and concentric rotation of the shaft relative to the SCB assembly 101, provisions are included to fix the bearing assembly 134 from shifting or play due to the loose fit configuration when first assembled and after allowing the assembled components to settle to their lowest constraint. In this lowest constraint, the shaft's rotation is at its most optimal concentricity. In an example, one or more inlet ports 150 are provided on the can housing to provide access to the gap or space 154 between the bearing outer ring 136 and the interior surface of the second bore section 108b. Glue or epoxy glue can then be introduced into the space 154 and then allowed to cure to from a solid filler that fixes the outer ring 136 inside the can housing in the aligned position. Internal grooves and channels can be formed in the can housing or the outer ring as flow paths for the glue.

In an example, the glue or epoxy glue is selected to form a hardened filler to take up at least portions of the space 154 to delimit movement of the outer ring and to take up the loose fitting initial configuration. The glue or epoxy, or generally referred to as epoxy glue, should be compatible with the intended application. For example, if the pump is for a medical application, then the epoxy glue is selected to be biocompatible with the medical application, such as being compatible with blood and bodily fluids and is otherwise biologically inert. If the application is for oil and gas, as an example, then the epoxy glue is selected to be compatible with the oil and gas and non-reactive to any number of gases and compounds that can be found therein. In short, the epoxy glue can be any type that hardens up and has a good bond to fix the outer ring to the can housing and is compatible with the service application. After introducing the epoxy glue, it can be air cured or heat cured, such as in an oven or under a heat lamp.

In an example, one or more ports 150 can serve as a port for introducing the epoxy glue into the can housing and for venting. The one or more ports can be threaded for receiving a zerk fitting or other fittings for use with a tool to introduce the epoxy. Following the introduction, the fitting can be removed and the one or more ports can optionally be capped, although the cured epoxy can seal off the ports without necessarily using an external cap. The outer ring of the bearing assembly can align with the one or more ports. By aligning with the one or more ports, epoxy glue can readily flow into the space through the one or more ports and flow between the outer ring and the can housing to fix the outer ring from play when the epoxy hardens.

As shown, the equipment housing 146 can also incorporate one or more ports 156 that align with the one or more ports on the can housing. For example, if the alignment of the various components is to be fixed after assembly of the SCB assembly 101 and the shaft 144 in the equipment housing, then the one or more ports 156 of the equipment housing would allow access to the one or more ports 150 on the can housing to allow access to the space 154. If the epoxy is introduced in the space 154 before assembly of the SCB assembly 101 into the equipment housing, then the one or more ports 156 on the equipment housing can be omitted.

Thus, aspects of the present include a seal cartridge and bearing assembly and wherein a gap or space is provided between the outer ring of the bearing assembly and the interior of the can or can housing to allow the outer ring to move or adjust to facilitate alignment. The gap or space can then be taken up with a material that has a first state, in which the material is flowable, and a second state in which the material hardens and is not flowable. In an example, the flowable material is introduced into the gap or space from a location external of the can housing or cartridge and flows into the cartridge. For example, one or more ports can be provided on or in the can housing to allow epoxy to be introduced into the can housing. In an example, the flowable material is epoxy or epoxy glue. The epoxy glue can be cured to form a hardened material and take up at least some or all of the space or gap between the outer ring of the bearing assembly and in the interior of the can housing to constrain the outer ring from further movement after allowing the components to settle to their collective lower flexed state. The epoxy is preferably introduced into the gap or space after assembly of a shaft in through both the bore of the inner ring of the bearing assembly and the bore of the seal assembly, which can have a single seal element or two seal elements. If two seal elements are utilized, the two seal elements preferably face one another. That is, each inside flange has a free end and wherein the free end of the two seal elements face one another or point at one another.

In an example, the bearing assembly 134 is a ball bearing assembly and the rolling elements 142 are metal balls or spherical balls. When the bearing assembly 134 is a ball bearing assembly, the outer and inner rings 136, 138 can comprise inner and outer bearing races for the plurality of balls 142 to contact and rotate against. In other examples, the bearing assembly 134 can be a different bearing type, such as a roller bearing assembly, a tapered or angled roller bearing assembly, a thrust ball bearing assembly or a roller bearing assembly, etc. Rolling elements of a roller bearing assembly and tapered roller bearing assembly can embody solid rotating cylinders or solid tapered cylinders.

In an example, the outer ring 136 comprises two grooves 152 on the exterior surface thereof to define three raised projections, as shown in FIG. 3. In other examples, one or more than two exterior grooves 152 and two or more than three raised projections can be incorporated. Further, for each projection, relatively smaller grooves, such as micro-grooves, can be provided on the exterior thereof to facilitate gripping or bonding of the outer ring 136 and the epoxy. The grooves 152, when incorporated, provide additional surfaces for cooperating or bonding with the epoxy. The grooves 152 also provide reservoir-like functions for accommodating working quantities of the epoxy that subsequently hardens to take up the loose fitting of the outer ring. In some examples, epoxy glue in a flowable first state can be added to the grooves 152 prior to inserting of the bearing assembly into the can housing 104. In addition, epoxy glue can be added to the gap 154 after installation of the bearing assembly to the can housing via the one or more ports 150. Once epoxy cures, the opening to the one or more ports can be left as shown. In alternative examples, a cap can be placed over each opening 158 of the one or more ports. The cap can be pressed fitted to the port or can be threaded to the port.

With further reference again to FIGS. 1 and 2, the can or cartridge 106 for retaining the seal assembly 102 comprising two seal elements 110, 112 has a body comprising a wall with an exterior wall surface and an interior wall surface defining a bore 108, as previously discussed. The exterior wall surface of the can or can housing is shown with one or more shoulders, ribs, lips, lines, and/or curvatures for mating with the equipment housing 146. However, the exterior can be adopted to have different configurations, such as a differently located shoulder or lip, for use with differently shaped equipment housings. The body can have two open ends for assembling the seal assembly 102 and the bearing assembly 134 from either open end of the body. In the present embodiment, a retaining wall 160 is provided at one of the two ends of the body to define a retaining end, which prevents components of the seal assembly 102 and bearing assembly 134 from escaping from the bore 108 out through the retaining end. The retaining wall 160 can be unitarily formed with the body of the cartridge. Optionally and less preferred, the retaining wall can be a separately formed disc that is secured to the cartridge by press fir or interference fit. By default, the opposite end of the body, when the body has the retaining wall, is the insertion end or the assembly end, for placement of the seal assembly and the bearing assembly into the bore 108 to form the SCB assembly 101 in accordance with aspects of the invention. In alternative embodiments, where a retaining wall is shown or used, an open cylinder and a retaining disc may instead be used. In other words, the cylinder may have two open ends with two retaining discs and wherein the retaining discs are secured to the bore via interference or press fit.

In some examples, no washers are used with the seal cartridge assembly. In some examples, a washer 162 is provided between the first seal element 110 and the retaining wall 160. The washer 162 is located between the first seal element and the retaining wall can be referred to as a first washer 162a if additional washers are incorporated with the SCB assembly 101. The washer 162 can be made from an elastomeric material, thermoplastic material, such as PTFE, PE or PEEK, or any other special polymers; and can be incorporated in a primary seal and secondary seal configuration. The first washer 162a has a body with an outside perimeter having a diameter (OD), and inside perimeter having an inside diameter (ID), and a thickness defined between two opposing faces. The OD can extend outwardly and touches the interior surface of the cartridge but may be spaced from the interior surface by a gap. The ID is preferably sized to form an interference fit around the shaft when the seal cartridge is mounted on the shaft, as shown in FIG. 2. The first washer is preferably compressed between the retaining wall 160 and the center channel section 121 of the first sealing element. As configured, the first washer 162a is a sealing washer in that the interference fit at the ID with the shaft provides a sealing point in addition to the inside flange of the first seal element to seal against external environment pressure 170 from leaking into the spring cavity 174 via the interface at the shaft. Service grease may optionally be used in the spring cavity 174 to provide lubrication and limit fluid incursion into the spring cavity. The service grease can be selected for the particular application, such as being selected to be biocompatible.

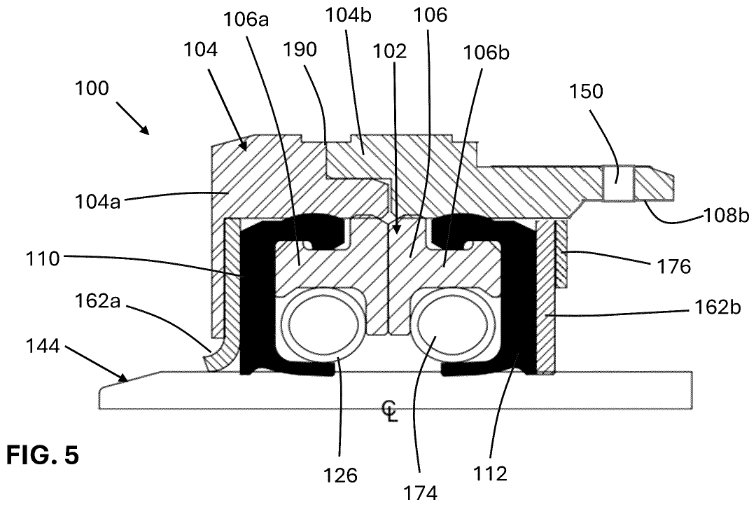

In some examples, the first washer 162a can have a memory lip at the ID, which has a curved portion at the ID and wherein the curved portion can extend away from the spring cavity 174, as shown in FIG. 5. The memory lip may be molded along with the planar body of the first washer to have the curved portion. The curved portion of the memory lip is curved or arcuate such that a lip seal is formed that contracts the OD of the shaft to seal against the shaft while the opposing surface is spaced away or does not contact the shaft. When the washer is provided with a memory lip that functions as a lip seal to seal against the shaft, the washer may be referred to as a lip seal. The lip seal of the first washer provides another dynamic seal for the cartridge seal of the present embodiment, which in combination with the first and second seal elements provide three dynamic sealing points or three dynamic seals with the shaft.

When incorporated, the memory lip defines an inside opening of the washer, inwardly of the washer's outer perimeter. The inside opening, or just opening for short, has a diameter that is smaller than the OD of the shaft so as to be in an interference with the shaft. Preferably, the inside diameter of the opening is the same as or smaller than the inside diameter of the inside flange so as to have a higher interference than the inside flange. The washer 162a is configured to be oriented so that the ID opening, such as the end edge between the two surfaces, faces the high pressure region 170. Thus, a pocket is formed immediately behind the opening and is oriented away from the media that the washer 162a is to seal against, thereby minimizing the possibility of a material buildup at the pocket.

With reference again to FIG. 1, another washer 162b can be provided between the second seal element 112 and a retaining disc 176, which is attached to the can housing in a press-fit or interference fit manner to hold and/or retain the seal assembly 102 in place following assembly. The retaining disc 176 should have an ID opening that is sufficiently larger than the shaft OD to avoid contact with the shaft during assembly and service. The second washer 162b can be the same or similar to the first washer 162a. The second washer 162b can be a straight or a flat washer as shown with an inside perimeter having an ID that seals against the shaft OD to provide another sealing point for the seal cartridge. Alternatively, the second washer 162b can have a memory lip that functions as a lip seal with an opening that faces away from the second seal element, facing the external region 172.

The seal elements 110, 112 of the seal assembly 102 may be practiced with a traditional rounded corner at the exterior interface between the inside flange and the center channel section, as shown with reference to FIG. 4 and further discussed below. In some examples, the first seal element 110 incorporates an excluder 180. The excluder 180 can be provided at an end of the center channel section 120, on the inside flange 116 side of the seal element. Said differently, an excluder 180 is provided at an end of the inside flange 116, opposite the free end of the inside flange. The excluder 180 can be singularly formed with the body of the seal element 110 and can be provided with an inside diameter (ID) that is smaller than the inside diameter of the inside flange at the inside sealing lip and/or the outside diameter of the shaft 144. The excluder 180 can have a fin-like cross-section with a flat or blunt tip that seals against the shaft. The sealing edge of the excluder 180 is located next to an annular recess 182. The annular recess presents a discontinuity along the inside of the sealing flange. 110 In other words, the inside flange 116 is separated from the excluder 180 by the annular recess 182. The tight fitting excluder 180 around the outside diameter (OD) of the shaft 144 helps to prevent fluid located external of the spring cavity 174 from entering the spring cavity past the excluder 180 and into the interface between the shaft and the inside flange and possibly interferes with the dynamic seal or presents a difficult media for the seal to maintain. Thus, the excluder 180 provides an additional sealing point for the cartridge seal against the exterior of the shaft.

In an example, the second sealing element 112 can incorporate a similar excluder as the first sealing element 110. Optionally, the second sealing element 112 can be practiced with a rounded interface between the inside flange and the center channel section that is spaced from the exterior of the shaft.

With reference now to FIG. 3, a cartridge seal and bearing assembly (CSB assembly) 100 in accordance with further aspects of the invention is shown. The present CSB assembly 100 is similar to the CSB assembly 100 of FIGS. 1 and 2 with a few modifications or differences. For example, the present CSB assembly has two seal elements, two sealing washers at two ends, and a bearing assembly. In the present embodiment, the structural component 106 is split into two separate or distinct structural components, which may be referred to as a first structural component section 106a and a second structural component section 106b. The two structural component sections are mounted in direct contact with one another along a seam. Each of the two structural components sections can include a flange extension 128 that extend into the cavity 174 and a flange stub 130. Optionally, one of the two flange extensions can be omitted. In the present embodiment, the flange stub 130 extends radially outwardly away from the cavity 174 and contacts the interior surface of the can housing or cartridge 104. In other examples, each flange stub 130 is shortened and does not contact the interior surface of the can housing.

Optionally, to isolate the cavity 174 into two or more isolated cavities, one or more sealing washers 186 can be incorporated at the cavity 174. As shown, two sealing washers 186 are provided, one with each structural component section and can be called internal sealing washers. Each internal sealing washer 186 has an outside perimeter with an OD that is substantially smaller than the OD of the end sealing washers, 162a, 162b, which can optionally be omitted. The OD of the internal sealing washer preferably extends to contact the body of the structural component section and the inside perimeter with the ID is sized for sealing against the OD of the shaft 144 and is therefore smaller than the OD of the shaft. One or both internal sealing washers can incorporate a memory lip at the ID or both can have flat bodies or flat sealing washers.

In the present embodiment, the second sealing washer 162b is thicker than the first sealing washer 162a and has two thickness sections. The present second sealing washer 162b is configured to provide both a sealing function and a retaining function, for retaining the seal assembly within the cartridge when supported by the outer ring 136 of the bearing assembly. In other examples, the second outside sealing washer 162b can be separated into a sealing washer and a retaining disc, similar to the sealing washer and retaining disc shown in FIG. 1. The thinner section of the second sealing washer 162b spaces the body of the second sealing washer from the inner ring 138 of the bearing assembly so that when the inner ring 138 rotates with the shaft, the inner ring does not rub against the body of the second sealing washer.

In the present embodiment, the first sealing element 110 has an excluder, similar to that shown in FIG. 1. The second sealing element 112 however differs in that it has a relatively longer center channel section than the first sealing element and a larger OD defined by the outside flange 118. The first sealing element is configured to seal against the first bore section 108a with a first inside diameter and the second sealing element is configured to seal against the second bore section of the can housing having a second inside bore diameter, which is larger than the first bore inside diameter.

The can housing 104 is provided with one or more inlet ports 150 for filling the space 154 between the outer ring 136 of the bearing assembly 134 and the interior surface of the can housing with epoxy glue, similar to the one or more ports discussed with reference to FIGS. 1 and 2. The outer bearing 136 can be provided with grooves 152 for accommodating quantities of epoxy in the first state and then allowed to harden in the epoxy's second state to take up the loose fitting arrangement of the outer ring relative to the can housing. Alternatively or in addition therewith, the interior of the bore can incorporate grooves for accommodating the epoxy. The exterior of the can housing 104 may incorporate shoulders, lips, flanges, and/or curvatures as needed to mate or fit any particular equipment housing as desired or necessary.

FIG. 4 shows a seal cartridge assembly 100 in accordance with still further aspects of the invention. The seal cartridge assembly 100 is shown with a seal assembly 102 and a can housing or cartridge 104 mounted onto a shaft 144. The cartridge 104 is shown schematically only and can include exterior surface features, such as shoulders, lips, flanges, and/or curvatures to mate with or mounted to any desired equipment housing. The assembly is also shown without a bearing assembly and without sealing washers but such components can be included like that of FIGS. 1-3, including having one or more ports for use to add epoxy glue to fix the outer ring of the bearing assembly.

The present seal assembly is similar to the seal assembly of FIGS. 1 and 2 with a few exceptions. In the present embodiment, the first and second sealing elements do not incorporate excluders. Instead, the exterior intersection at the inside flange and the center channel section is curved and spaced from the exterior of the shaft.

The structural component 106 is shown with a single unitarily formed body having a flange stub 130 that extends radially outwardly to contact the interior of the can housing 104. In an example, the flange stub 130 is in an interference fit with the bore of the can housing. However, the flange stub 130 can be practiced with a shortened flange stub so that it is spaced from the interior of the can housing, like that shown in FIGS. 1 and 2.

FIG. 5 shows a seal cartridge assembly 100 in accordance with still further aspects of the invention. The seal cartridge assembly 100 is shown with a seal assembly 102 and a can housing or cartridge 104 mounted onto a shaft 144. The cartridge 104 is shown schematically and includes a first cartridge component 104a mated to a second cartridge component 104b along a seam 190. The seam 190 can be a complex seam that is not purely linear or straight. The multi-piece cartridge 104 allows the components to be separated during assembly to simplify mounting the seal assembly 102, which has a structural component 106 that is split into two separate or distinct structural components 106a, 106b, similar to that of FIG. 3. Thus, during assembly, the first sealing washer 162, the first structural component 106a, and the first seal element 110 can be assembled into the first cartridge component 104a, via the opening proximate the seam. If an energizer 126 is used, it can be mounted in the spring cavity prior to assembly in the first cartridge component.

Similarly, the second sealing washer 162b, the second structural component 106b, and the second seal element 112 can be assembled into the second cartridge component 104b, via the opening proximate the seam. The retaining disc 176 can be mounted to the second cartridge component 104b prior to assembly of the second sealing washer 162b, the second structural component 106b, and the second seal element 112. If an energizer 126 is used, it can be mounted in the spring cavity prior to assembly in the second cartridge component. In some examples, the retaining disc 176 can be unitarily formed with the second cartridge component 104b. For example, a retaining wall, similar to the retaining wall 160 on the first cartridge component 104a, can be machined with the second cartridge component 104b rather than using a separately formed retaining disc. The two structural components 106a, 106b can be practiced without the exterior flange stubs or the flange stubs can be shortened to not contact the can housing during assembly.

When the first and second cartridge components are joined as shown, the cartridge 104 can include exterior surface features, such as shoulders, lips, flanges, and/or curvatures to mate with or mounted to any desired equipment housing. The assembled cartridge is shown with a bore having a first bore section 108a with a first bore diameter and a second bore section 108b with a second bore diameter. The second bore section 108b is configured to accommodate a bearing assembly, similar to that shown in FIGS. 1 and 2. In some examples, one or both sealing washers 162a, 162b can be omitted. In still other examples, one or two internal small diameter sealing washers 186 similar to those shown in FIG. 3 can be incorporated.

Further, as the bearing assembly is configured to fit within the second bore section 108b in a loose fit, one or more inlet ports 150 can be provided with the second bore section 108b of the second cartridge component 104b for adding epoxy glue to fill the gap between the outer ring of the bearing assembly and the interior surface of the second bore section 108b with a hardened material to fix the outer ring from shifting or moving, as previously discussed. An outer ring is understood to be in a loose fitting arrangement when there is some play that allows the outer ring to move by hand and the outer ring is not press fitted or in an interference fit with the interior surface of the bore. As a loose fitting outer ring can generate unwanted vibrations during service, the outer ring can be fixed to the can housing with epoxy that when hardens, secures the outer ring from moving relative to the can housing.

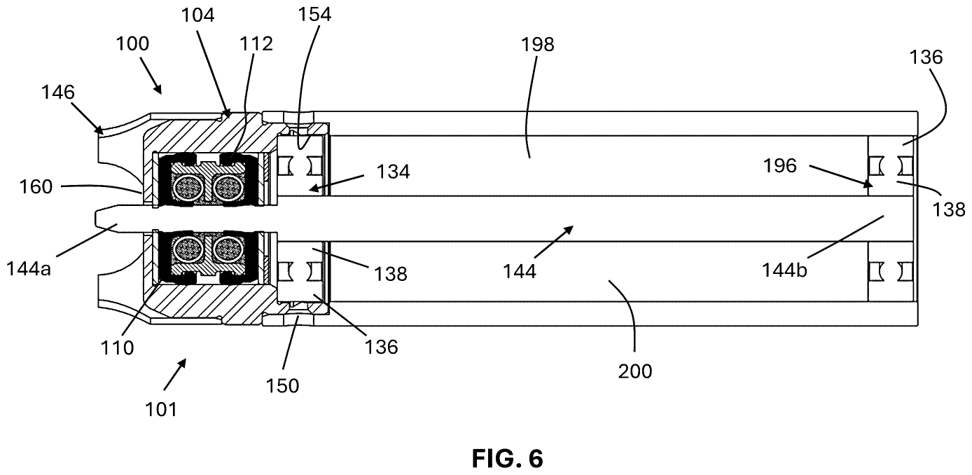

With reference now to FIG. 6, a cross-sectional side view of a seal cartridge 100 and a bearing assembly 134 defining an SCB assembly 101 in accordance with further aspects of the invention is shown. The SCB assembly 101 is mounted inside an equipment housing 146, similar to the SCB assembly of FIG. 2. In the present embodiment, the shaft 144 is supported by a second bearing assembly 196 located remotely from the first bearing assembly 134 by at least two times the width of the first bearing assembly 134, such as five times or more than the width. In an example, the first bearing assembly 134 is located in the bore of the cartridge housing while the second bearing assembly 196 is located in the equipment housing. The spacing between the two bearing assemblies can vary depending on the applications and each bearing assembly size and rating can be selected for the applications.

In an example, the equipment housing 146 can be a test fixture, a pump, or motor, etc. and the specific housing geometry can vary without deviating from the scope of the invention. The shaft 144 can have a first end 144a and a second end 144b. If the equipment housing is a pump, then the first end 144a can be a working end and can include an impeller (not shown). Because the impeller is located to one side of the two bearing assemblies 134, 196, the pump can be referred to as an overhung pump. The cavity 198 between the two bearing assemblies can be an oil sump 200, which can be provided with oil for lubricating the bearings when they rotate during service. Alternatively, the bearing assemblies can be sealed bearings that are packed with lubricating grease.

The present SCB assembly 101 may comprise sealing washers, similar to the sealing washers in embodiment of FIG. 2. Optionally, the washers can be omitted. The cartridge housing 104 may incorporate a retaining wall 160 defining a closed end and a retaining disc 176 at the opposite assembly end. The cartridge housing 104 may include two internal bore sections and one or more ports 150 for introducing epoxy glue to fix the outer ring 136 of the bearing assembly 134 to the housing 104 after allowing the bearing assembly 134, shaft 144, and seal assembly 102 to settle and align, as previously discussed. In the present embodiment, the second bearing assembly 196 is mounted to the shaft 144 and the equipment housing 146 prior to fixing the outer ring 136 of the first bearing assembly 134 to the can housing 104 via epoxy glue, as further discussed below. Thus, the outer ring 136 of the first bearing assembly 134 can be in a loose fitting arrangement within the bore of the can housing during initial installation. One or more grooves can be provided at the exterior surface of the outer ring 136 to facilitate flow and accommodate quantities of the epoxy.

The second bearing assembly 196 may be assembled to the cartridge housing 104 and the shaft 144 via press fitting. That is, the outer ring 136 of the second bearing assembly can be pressed fitted to the bore of the equipment housing and the inner ring 138 can be pressed fitted onto the shaft 144. However, because the first seal element 110 and the second seal element 112 are compressible and because a gap 154 is provided between the outer ring 136 and the bore of the can cartridge 104, the shaft and the various components are allowed to settle to their lowest combined misalignment position. The gap 154 can then be taken up to rigidly support the outer ring 136 to the housing 104, such as by introducing epoxy glue into the gap 154 via the one or more ports 150 and then allowing the epoxy glue to harden to fix the outer ring inside the bore. In some examples, the outer ring 136 of the second bearing assembly 196 can also be in a loose fitting arrangement with the bore of the equipment housing. The loose fitting arrangement of the outer ring can subsequently be taken up via epoxy. If the second bearing assembly 196 is also in a loose fitting arrangement, the loose fitting arrangement of the second bearing assembly 196 can be taken up first before the loose fitting arrangement of the first bearing assembly.

Thus, aspects of the invention are understood to include cartridge seal and bearing system comprising a cartridge seal and bearing system comprising: a can housing having a body having a wall with an interior surface defining a bore having a first end and a second end, the first end having a retaining wall or a retaining disc, and one or more inlet ports formed through the wall for dispensing epoxy glue therethrough; a structural component having a body located in the bore of the can housing; a first seal element comprising an inside flange, an outside flange, and a center channel section located between the inside and outside flanges, the outside flange of the first seal element being pressed against the interior surface of the can housing by the structural component; a second seal element comprising an inside flange, an outside flange, and a center channel section located between the inside and outside flanges, the outside flange of the second seal element being pressed against the interior surface of the can housing by the structural component; a bearing assembly comprising an inner ring, an outer ring, and a plurality of rolling elements between the inner and outer rings, said bearing assembly located in the bore and closer to the second seal element than the first seal element; and wherein the outer ring is in a loose fit arrangement inside the bore when initially assembled inside the bore and is aligned with the one or more ports. The can housing or cartridge housing can be located in an equipment housing and wherein a second bearing assembly is spaced from the can housing. The outer ring of the first bearing assembly can have a loose fit with the bore of the can housing to allow the first bearing assembly, the second bearing assembly, and the seal assembly to settle to their lowest combined misalignment position relative to the shaft and the bore before taking up the slack or loose fit of the outer ring to rigidly secure the outer ring relative to the can housing.

Thus, aspects of the present invention is a combination seal cartridge 100 and bearing assembly 134 provided with a shaft and a second bearing assembly having reduced misalignment or out of alignment issues, or lowest constraint, by utilizing a loose fitting bearing ring and cartridge housing upon installation that is later taken up by hardened glue. Glue can be introduced after the seal cartridge 100, shaft 144, first bearing assembly 134, and second bearing assembly 196 are assembled to an equipment housing. At least one of the outer rings of the first or second bearing assembly is loosely fitted to the bore of the cartridge housing or equipment housing so that the various components settle to their lowest constraint and more centered than when none of the outer rings have a loose fit arrangement.

An aspect of the invention is further understood to include a method of aligning seal and bearing components comprising the use of glue having a flowable first state and a hardened second state in which the glue is not flowable. The bearing assembly can include a loose fitting arrangement with the bore of the cartridge housing and/or the equipment housing to allow the seal assembly, bearing assembly, and shaft to self-align and settle to their lowest constraint, and then glue is introduced to take up the loose fitting arrangement between the bearing assembly the bore of the cartridge housing and/or the equipment housing. Once the glue hardens, the various components are fixed in the lowest settled state so that when in service, the various components experience their lowest misalignment or out of center rotation.

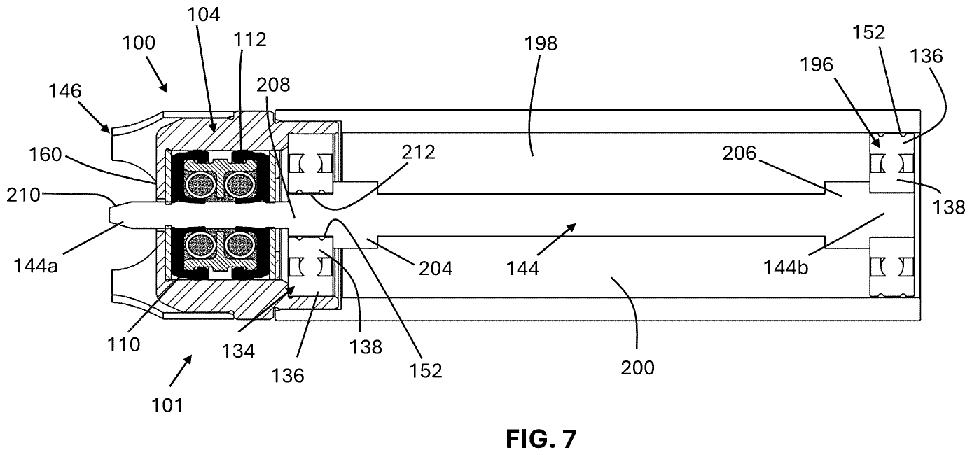

With reference now to FIG. 7, a cross-sectional side view of a seal cartridge 100 and a bearing assembly 134 defining an SCB assembly 101 in accordance with still further aspects of the invention is shown. The SCB assembly 101 is mounted inside an equipment housing 146, similar to the SCB assembly of FIGS. 2 and 6. In the present embodiment, the shaft 144 is supported by a second bearing assembly 196 located remotely from the first bearing assembly 134 by at least two times the width of the first bearing assembly 134, such as five times the width. In an example, the first bearing assembly 134 is located in the bore of the cartridge housing while the second bearing assembly is located in the equipment housing. The spacing between the two bearing assemblies can vary depending on the applications and each bearing assembly size and rating can be selected for the applications.

The present SCB assembly 101 is similar to the SCB assembly of FIG. 6 with the following exceptions. The shaft 144 incorporates a couple of stepped sections 204, 206. The first stepped section 204 is located adjacent the first bearing assembly 134 to fix the axial position of the first bearing assembly 134 relative to the shaft. The second stepped section 206 is provided near the second end 144b of the shaft to fix the axial position of the second bearing assembly 196 relative the shaft.

A third stepped section 208 can be provided at the first end of the shaft 144a. As shown, the shaft can have a tapered nose section 210 that expands to a constant diameter where the seal assembly 102 is positioned. The third stepped section 208 steps the shaft diameter up so that the inner ring 138 of the first seal assembly 134 is provided with a larger ID than the ID defined by the inside flanges of the two seal elements. However, the first stepped section, the second stepped section, or both can be omitted.

The second bearing assembly 196 may be assembled to the cartridge housing 104 and the shaft 144 via press fitting, similar to the embodiment of FIG. 6. That is, the outer ring 136 of the second bearing assembly can be pressed fitted to the bore of the equipment housing and the inner ring 138 can be pressed fitted onto the shaft 144. Optionally, exterior grooves 152, similar to that of FIG. 3, can be incorporated for the outer ring of the second bearing assembly to accommodate the epoxy glue.

In the present embodiment, the outer ring 136 of the first bearing assembly 134 is pressed fit to the bore of the cartridge housing 104 with no loose fit or gap between the outer ring 136 and the interior surface of the bore. Thus, the one or more ports formed through the wall of the cartridge housing for introducing epoxy glue can be omitted. Instead, a gap or space 212 for loose fitting is provided between the shaft 144 and the inside diameter of the inner ring 138 such that there is a loose fit between the inner ring and the shaft. Because the first seal element 110 and the second seal element 112 of the seal assembly are compressible and because a gap 212 is provided between the inner ring 138 and the shaft 144, the shaft and the various components are allowed to settle to their lowest combined misalignment position. The gap 212 can then be taken up to rigidly support the inner ring 138 to the shaft 144, such as by introducing epoxy glue into the gap 212 and then allowing the epoxy glue to harden to fix the inner ring of the first seal assembly relative to the shaft.

In an example, glue or epoxy in flowable form can first be provided at the section of the shaft adjacent the first stepped section 204 during assembly of the shaft into the common bore defined by the first bearing assembly 134 and the seal assembly 110. Thus, glue can be provided at the gap 212 between the inner ring 138 and the shaft 144. Because glue in a first state is still flowable and has not hardened, the glue cannot exert any force on the shaft or the cartridge, so the cartridge and the shaft can settle to their lowest constraint as the glue cures.

In an example, the interior surface of the inner ring 138 of the first bearing assembly 134 is supplied or provided with grooves 152 at the bore of the inner ring, wherein the grooves are similar to the grooves on the exterior surface of the outer ring 136 of FIG. 3. These grooves 152 on the inner ring can hold adhesive or epoxy that is applied before the shaft is inserted in through the bore of the bearing assembly. That way the adhesive or epoxy can be brought to the interface between the inner ring and the shaft upon insertion of the shaft into the bore of the inner ring. The epoxy glue can be selected with the desire viscosity to minimize free flowing and to enable proper application of the epoxy at the third stepped section 208 of the shaft 144. Once the epoxy hardens, the inner ring 138 is secured from moving relative to the shaft. Thus, use of the first smaller diameter section at the first end and then stepping up to a larger diameter for the first bearing assembly 134 allows for the shaft 144 to be inserted into the cartridge housing with the first seal assembly and the first bearing assembly already mounted therein. Further, the smaller shaft section can pass through the inner ring 138 of the first bearing assembly without smearing against the epoxy glue.

In an example, that the outer ring 136 of the second bearing assembly 196 can be supplied with similar grooves 152 on the OD of the outer ring. The grooves 152 allow for the application of adhesive to the interface between the outer ring and the interior of the equipment housing, such as a motor housing or equipment housing. Thus, optionally the outer ring of the second bearing assembly can also have a play fit or loose fit, the shaft 144 can align itself in the sealing elements of the cartridge.

In some examples, grooves for adhesive or epoxy can be provided on the shaft instead or in addition to the grooves on the inner surface of the inner ring 138 of the bearing assembly. Optionally, only the shaft can be provided with grooves and the inner surface of the inner ring can be kept flat, without grooves. That way the adhesive can be applied onto the grooves in the shaft and be brought to the interface between the inner ring and the shaft.

In some examples, the interface between second bearing assembly 196 and the motor housing or equipment housing 146 can be re-arranged. In an example, the motor housing or equipment housing can be provided with grooves for accommodating quantities of adhesive rather than grooves on the exterior of the outer ring of the second bearing assembly. Optionally, grooves can also be provided on the exterior of the outer ring.

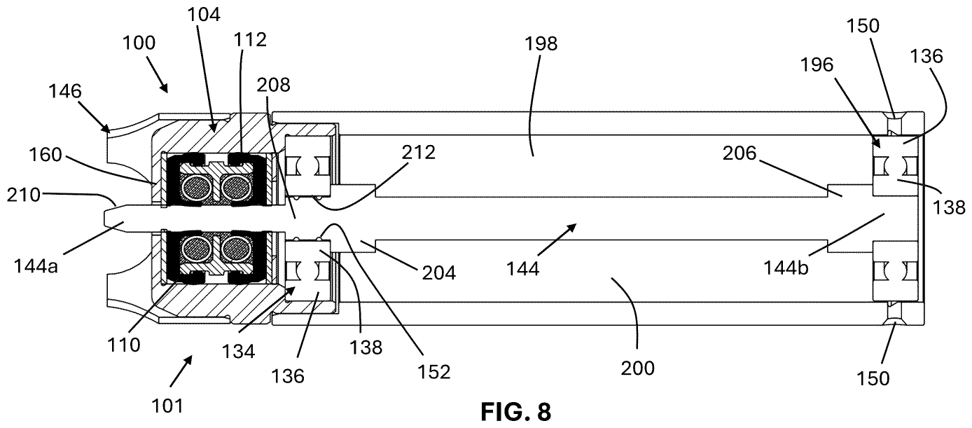

With reference now to FIG. 8, a cross-sectional side view of a seal cartridge 100 and a bearing assembly 134 defining an SCB assembly 101 in accordance with still further aspects of the invention is shown. The SCB assembly 101 is mounted inside an equipment housing 146, similar to the SCB assembly of FIGS. 2, 6, and 7. The present embodiment is particularly similar to the embodiment of FIG. 7 in that the shaft 144 is supported by a first bearing assembly 134 located inside the cartridge housing 104 and wherein the loose fit is between the inner ring 138 of the first bearing assembly and the shaft 144.

In the present embodiment, the second bearing assembly 196 is located in the equipment housing 146, such as a pump housing or a motor housing, and the equipment housing is provided with one or more inlet ports 150, similar to the one or more inlet ports discussed with reference to FIGS. 2, 3, and 6. Thus, the outer ring 136 of the second bearing assembly 196 can be in a loose fit arrangement with the equipment housing 146 to allow alignment of the shaft to the seal assembly and the two bearing assemblies. As previously discussed, glue or epoxy in a flowable first state can then be introduced in through the one or more ports 150 to flow into the gap 154 between the outer ring and the equipment housing. The glue is then allowed to hardened in a second state to take up the loose fit and secure the outer ring from moving relative to the equipment housing.

Thus, aspects of the present invention is a combination seal cartridge 100 and bearing assembly 134 provided with a shaft and a second bearing assembly having reduced misalignment or out of alignment issues, or lowest constraint, by utilizing a loose fitting bearing ring and cartridge housing upon installation that is later taken up by hardened glue. Glue can be introduced after the seal cartridge 100, shaft 144, first bearing assembly 134, and second bearing assembly 196 are assembled to an equipment housing. At least one of the inner rings of the first or second bearing assembly is loosely fitted to the shaft OD so that the various components settle to their lowest constraint and more centered than when none of the inner rings have a loose fit arrangement with the shaft.

An aspect of the invention is further understood to include a method of aligning seal and bearing components comprising the use of glue having a flowable first state and a hardened second state in which the glue is not flowable. The bearing assembly can include a loose fitting arrangement with the shaft to allow the seal assembly, bearing assembly, and shaft to self-align and settle to their lowest constraint, and then glue is allowed to harden to take up the loose fitting arrangement between the bearing assembly the shaft. Once the glue hardens, the various components are fixed in the lowest settled state so that when in service, the various components experience their lowest misalignment or out of center rotation. The comparison is made to similar components, assemblies, and systems without the analogous alignment features. The term loose fitting, or similar terms, means the outer ring or the inner ring of the bearing assembly is not in a pressed fit arrangement with either the can housing or the shaft, as the case may be.

A still further aspect of the invention is a method of using seal cartridge and bearing assemblies, pre-packaged seal and bearing systems, and pre-packaged seal and bearing assemblies as shown and described.

A still further aspect of the invention is a method of manufacturing or making using seal cartridge and bearing assemblies, pre-packaged seal and bearing systems, and pre-packaged seal and bearing assemblies as shown and described.

The various seal and bearing assemblies, gaskets or washers, pre-packaged seal and bearing systems, and pre-packaged seal and bearing assemblies can be interchangeable unless the components are mechanically or operationally conflicting. For example, the cylinder of FIG. 1 may be replaced with the split cylinder of FIG. 5, and the washers of FIG. 5 may be replaced with the washers of FIG. 1. As additional examples, the single sealing washer with memory lip of FIG. 5 may be modified to be a stacked washer in which two back-to-back washers may be used. Further, where only a single sealing washer is shown, a stacked washer assembly with two or more sealing washer may be used. In yet another example, where a seal element is shown with an integrated excluder, a different seal element with an excluder may be used. Thus, the various embodiments described herein are intended to be interchangeable where they are compatible to do so.

As another example, various cylinders or can housings have outer contours that can be sized and shaped to fit different operating environments or equipment housing that call for the combination seal and bearing assembly of the present disclosure. As such, various steps, shoulders, and split lines may be incorporated to adapt to the environment for which the particular cylinder or can housing is used. For example, a single shoulder may be used on the exterior of the cylinder for one application while multiple shoulders or steps may be used for the same cylinder in another application.

Although limited embodiments of seal and bearing assemblies, gaskets, pre-packaged seal and bearing systems, and pre-packaged seal and bearing assemblies and their components have been specifically described and illustrated herein, many modifications and variations will be apparent to those skilled in the art. Accordingly, it is to be understood that the seal and bearing assemblies, gaskets, pre-packaged seal and bearing systems, and pre-packaged seal and bearing assemblies and their components constructed according to principles of the disclosed devices, systems, and methods may be embodied other than as specifically described herein. The disclosure is also defined in the following exemplary claims.

### Example Embodiments

The following are numbered example embodiments of methods, systems, and devices involving cartridge seals, seal and bearing systems, and methods of aligning components of a cartridge seal and bearing system, among others. The following examples, or any other examples disclosed herein, may be combined in whole or in part unless indicated otherwise. Elements of the examples disclosed herein, if applicable, are not limiting.

Example 1. A cartridge seal and bearing system comprising: a can housing having a body having a wall with an interior surface defining a bore having a first end and a second end, the first end having a retaining wall or a retaining disc; a structural component having a body located in the bore of the can housing; a first seal element comprising an inside flange, an outside flange, and a center channel section located between the inside and outside flanges, the outside flange of the first seal element being pressed against the interior surface of the can housing by the structural component; a second seal element comprising an inside flange, an outside flange, and a center channel section located between the inside and outside flanges, the outside flange of the second seal element being pressed against the interior surface of the can housing by the structural component; a first sealing washer located in the bore between the adjacent the retaining wall or the retaining disc and the first seal element, the first sealing washer having a body with an outside perimeter and an opening with an inside perimeter; a second sealing washer located in the bore and in contact with the center channel section of the second sealing element, the second sealing washer having a body with an outside perimeter and an opening with an inside perimeter; a bearing assembly comprising an inner ring, an outer ring, and a plurality of rolling elements between the inner and outer rings, said bearing assembly located in the bore and closer to the second seal element than the first seal element; and wherein the outer ring is in a loose fit arrangement inside the bore when initially assembled inside the bore or the inner ring is in a loose fit arrangement with a shaft when the shaft is inserted in through the inner ring.

Example 2. The assembly, system, device, apparatus, and method of any of the above Examples alone or in combination, further comprising a second retaining wall or retaining disc located between the second sealing washer and the bearing element.

Example 3. The assembly, system, device, apparatus, and method of any of the above Examples alone or in combination, wherein the can housing with the body has a split line that separates the can housing into a first can housing component and a second can housing component.

Example 4. The assembly, system, device, apparatus, and method of any of the above Examples alone or in combination, wherein the structural component has a multi-piece body comprising a first structural component section and a second structural component section.

Example 5. The assembly, system, device, apparatus, and method of any of the above Examples alone or in combination, wherein the first structural component has a lip that mechanically engages with a lip on the outside flange of the first sealing element.

Example 6. The assembly, system, device, apparatus, and method of any of the above Examples alone or in combination, wherein the second structural component has a lip that mechanically engages with a lip on the outside flange of the second sealing element.

Example 7. The assembly, system, device, apparatus, and method of any of the above Examples alone or in combination, further comprising a canted coil spring biasing against the structural component and the inside flange of the first sealing element.

Example 8. The assembly, system, device, apparatus, and method of any of the above Examples alone or in combination, further comprising a second canted coil spring biasing against the structural component and the inside flange of the second sealing element.

Example 9. The assembly, system, device, apparatus, and method of any of the above Examples alone or in combination, wherein the plurality of rolling elements comprise a plurality of spherical balls.

Example 10. The assembly, system, device, apparatus, and method of any of the above Examples alone or in combination, wherein epoxy glue is located in a space between the outer ring and the interior surface of the can housing when in a first state, in which the epoxy glue is flowable.

Example 11. The assembly, system, device, apparatus, and method of any of the above Examples alone or in combination, wherein the epoxy glue has a second state in which the epoxy glue hardens and is not flowable.

Example 12. The assembly, system, device, apparatus, and method of any of the above Examples alone or in combination, wherein the bore of the can housing has a first bore section with a first inside diameter and a second bore section with a second inside diameter, which is larger than the first inside diameter.

Example 13. The assembly, system, device, apparatus, and method of any of the above Examples alone or in combination, wherein the bearing assembly is located in the second bore section.

Example 14. The assembly, system, device, apparatus, and method of any of the above Examples alone or in combination, further comprising a shaft projecting through the inner ring of the bearing assembly and a bore of the cartridge seal.

Example 15. The assembly, system, device, apparatus, and method of any of the above Examples alone or in combination, wherein the bore of the cartridge seal is defined by the inside flange of the first seal element, the inside flange of the second seal element, and a passage through the structural component.

Example 16. The assembly, system, device, apparatus, and method of any of the above Examples alone or in combination, wherein the can housing and the shaft are located in an equipment housing.

Example 17. The assembly, system, device, apparatus, and method of any of the above Examples alone or in combination, wherein the equipment housing is a pump or a test assembly.

Example 18. The assembly, system, device, apparatus, and method of any of the above Examples alone or in combination, wherein the first sealing washer has a memory lip having a curved portion at the opening of the inside perimeter.

Example 19. The assembly, system, device, apparatus, and method of any of the above Examples alone or in combination, wherein both the outside perimeter of the first sealing washer and the outside perimeter of the second sealing washer contact the interior surface of the can housing.

Example 20. The assembly, system, device, apparatus, and method of any of the above Examples alone or in combination, wherein the bore of the can housing has a generally constant inside diameter from the first end to the second end.

Example 21. The assembly, system, device, apparatus, and method of any of the above Examples alone or in combination, wherein the first seal element has an excluder and an annular recess at an end of the inside flange and an end of the center channel section.

Example 22. The assembly, system, device, apparatus, and method of any of the above Examples alone or in combination, wherein the second seal element has an excluder and an annular recess at an end of the inside flange and an end of the center channel section.

Example 23. The assembly, system, device, apparatus, and method of any of the above Examples alone or in combination, wherein the first seal element has a free end and the second seal element has a free end, and wherein the two free ends point at one another.

Example 24. The assembly, system, device, apparatus, and method of any of the above Examples alone or in combination, wherein the structural component has a flange stub, and wherein the flange stub is spaced from the interior surface of the can housing.

Example 25. The assembly, system, device, apparatus, and method of any of the above Examples alone or in combination, further comprising service grease located in a spring cavity defined by the first sealing element.

Example 26. The assembly, system, device, apparatus, and method of any of the above Examples alone or in combination, further comprising service grease located in a spring cavity defined by the second sealing element.

Example 27. A cartridge seal and bearing system comprising: a can housing having a body having a wall with an interior surface defining a bore having a first end and a second end, the first end having a retaining wall or a retaining disc; a structural component having a body located in the bore of the can housing; a first seal element comprising an inside flange, an outside flange, and a center channel section located between the inside and outside flanges, the outside flange of the first seal element being pressed against the interior surface of the can housing by the structural component; a second seal element comprising an inside flange, an outside flange, and a center channel section located between the inside and outside flanges, the outside flange of the second seal element being pressed against the interior surface of the can housing by the structural component; a bearing assembly comprising an inner ring, an outer ring, and a plurality of rolling elements between the inner and outer rings, said bearing assembly located in the bore and closer to the second seal element than the first seal element; and wherein the outer ring is in a loose fit arrangement inside the bore when initially assembled inside the bore or the inner ring is in a loose fit arrangement with a shaft when the shaft is inserted in through the inner ring.

Example 28. A method of assembling a pre-packaged cartridge and bearing system comprising: providing a can housing having a body having a wall with an interior surface defining a bore having a first end and a second end, the first end having a retaining wall or a retaining disc, and one or more inlet ports formed through the wall for dispensing epoxy glue therethrough; placing a seal assembly inside the bore, the seal assembly comprising: a structural component having a body located in the bore of the can housing; a first seal element comprising an inside flange, an outside flange, and a center channel section located between the inside and outside flanges, the outside flange of the first seal element being pressed against the interior surface of the can housing by the structural component; a second seal element comprising an inside flange, an outside flange, and a center channel section located between the inside and outside flanges, the outside flange of the second seal element being pressed against the interior surface of the can housing by the structural component; a first sealing washer located in the bore between the adjacent the retaining wall or the retaining disc and the first seal element, the first sealing washer having a body with an outside perimeter and an opening with an inside perimeter; a second sealing washer located in the bore and in contact with the center channel section of the second sealing element, the second sealing washer having a body with an outside perimeter and an opening with an inside perimeter; placing a bearing assembly inside the bore, the bearing assembly comprising an inner ring, an outer ring, and a plurality of rolling elements between the inner and outer rings, said bearing assembly located in the bore and closer to the second seal element than the first seal element; and wherein the outer ring is in a loose fit arrangement inside the bore when initially assembled inside the bore and is aligned with the one or more ports.

Example 29. The assembly, system, device, apparatus, and method of any of the above Examples alone or in combination, further comprising placing a shaft through the inner ring of the bearing assembly and a bore of the seal assembly.

Example 30. The assembly, system, device, apparatus, and method of any of the above Examples alone or in combination, further comprising adding epoxy glue through the one or more ports.

Example 31. The assembly, system, device, apparatus, and method of any of the above Examples alone or in combination, further comprising curing the epoxy glue to fix the outer ring from moving.

Example 32. A method of assembling a pre-packaged cartridge and bearing system comprising: providing a can housing having a body having a wall with an interior surface defining a bore having a first end and a second end, the first end having a retaining wall or a retaining disc, and one or more inlet ports formed through the wall for dispensing epoxy glue therethrough; placing a seal assembly inside the bore, the seal assembly comprising: a structural component having a body located in the bore of the can housing; a first seal element comprising an inside flange, an outside flange, and a center channel section located between the inside and outside flanges, the outside flange of the first seal element being pressed against the interior surface of the can housing by the structural component; a second seal element comprising an inside flange, an outside flange, and a center channel section located between the inside and outside flanges, the outside flange of the second seal element being pressed against the interior surface of the can housing by the structural component; placing a bearing assembly inside the bore, the bearing assembly comprising an inner ring, an outer ring, and a plurality of rolling elements between the inner and outer rings, said bearing assembly located in the bore and closer to the second seal element than the first seal element; and wherein the outer ring is in a loose fit arrangement inside the bore when initially assembled inside the bore and is aligned with the one or more ports.

Example 32. A method of aligning components inside a can housing of a cartridge seal by introducing glue that is flowable in a first state inside the can housing and allowing the glue to harden and not flowable in a second state.

Example 33. A method of aligning components inside an equipment housing by introducing glue that is flowable in a first state inside the equipment housing and allowing the glue to harden and not flowable in a second state.

Example 34. The assembly, system, device, apparatus, and method of any of the above Examples alone or in combination, wherein the components comprise a bearing assembly and a seal assembly having a structural component.

Example 35. The assembly, system, device, apparatus, and method of any of the above Examples alone or in combination, further comprising placing a shaft through the bearing assembly and the seal assembly prior to introducing glue in the first state.

Example 36. A method of aligning components inside an equipment housing that has a can housing of a cartridge seal located therein, the method comprising introducing glue that is flowable in a first state and allowing the glue to harden and not flowable in a second state.

Example 37. A method of aligning components inside an equipment housing that has a can housing of a cartridge seal located therein, the method comprising introducing glue that is flowable in a first state and allowing the glue to harden and not flowable in a second state.

Example 38. The assembly, system, device, apparatus, and method of any of the above Examples alone or in combination, further comprising placing a shaft through the cartridge seal prior to introducing glue.

Example 39. A method of aligning components inside a can housing of a cartridge seal comprising placing a seal assembly and a bearing assembly inside a bore of the can hosing, placing a shaft through a center of the bearing assembly and a center of the seal assembly, providing loose fitting so that an outer ring of the bearing assembly settles to its lowest constraint or allowing an inner ring of the bearing assembly to settle to its lowest constraint, and placing glue that is flowable in a first state inside the can housing to fix the outer bearing or the inner bearing from moving when the glue hardens and not flowable in a second state.

Example 40. The assembly, system, device, apparatus, and method of any of the above Examples alone or in combination, wherein the can housing is located in an equipment housing.

Example 41. The assembly, system, device, apparatus, and method of any of the above Examples alone or in combination, further comprising a second bearing assembly located inside the equipment housing and spaced from the can housing.

Example 42. The assembly, system, device, apparatus, and method of any of the above Examples alone or in combination, wherein the second bearing assembly comprises an outer ring and an inner ring, and wherein the outer ring and the inner ring are both in a pressed fit configuration.

Example 43. The assembly, system, device, apparatus, and method of any of the above Examples alone or in combination, wherein the structural component is sized and shaped to press the outside flange of the first seal element against the can housing to provide a seal therebetween.

Example 44. The assembly, system, device, apparatus, and method of any of the above Examples alone or in combination, wherein the structural component is sized and shaped to press the outside flange of the second seal element against the can housing to provide a seal therebetween.

Example 45. The assembly, system, device, apparatus, and method of any of the above Examples alone or in combination, wherein the structural component is spaced from an interior surface of the can housing.

Example 46. The assembly, system, device, apparatus, and method of any of the above Examples alone or in combination, further comprising a canted coil spring located in a spring cavity defined at least in part by the first seal element.

Example 47. The assembly, system, device, apparatus, and method of any of the above Examples alone or in combination, wherein the canted coil spring comprises a plurality of interconnected coils that bias the inside flange and the outside flange of the first seal element away from one another.

Example 48. The assembly, system, device, apparatus, and method of any of the above Examples alone or in combination, wherein the canted coil spring comprises a plurality of interconnected coils that bias the inside flange of the first seal element and the structural component away from one another.

Example 49. The assembly, system, device, apparatus, and method of any of the above Examples alone or in combination, further comprising a second canted coil spring located in a spring cavity defined at least in part by the second seal element.

Example 50. The assembly, system, device, apparatus, and method of any of the above Examples alone or in combination, wherein the structural component comprises a flange stub located on an exterior of a cylinder.

Example 51. The assembly, system, device, apparatus, and method of any of the above Examples alone or in combination, wherein the flange stub contacts an interior surface of a can housing.

Example 52. The assembly, system, device, apparatus, and method of any of the above Examples alone or in combination, wherein the flange stub is spaced from an interior surface of a can housing.

Example 53. The assembly, system, device, apparatus, and method of any of the above Examples alone or in combination, wherein the structural component is slid into the bore of the can housing without the structural component contacting the interior surface of the can housing.

Example 54. The assembly, system, device, apparatus, and method of any of the above Examples alone or in combination, wherein an exterior of the can housing comprises at least one of a shoulder, a rib, a lip, a tapered surface, and curvatures for mating with the equipment housing.

Example 55. The assembly, system, device, apparatus, and method of any of the above Examples alone or in combination, further comprising an inside sealing washer located in a spring groove adjacent a canted coil spring.

Example 56. The assembly, system, device, apparatus, and method of any of the above Examples alone or in combination, wherein the inside diameter (ID) of the inner ring of the first bearing assembly is larger than an inside diameter defined by an inside flange of the first seal element.

Example 57. The assembly, system, device, apparatus, and method of any of the above Examples alone or in combination, wherein the inside diameter (ID) of the inner ring of the first bearing assembly is larger than an inside diameter defined by an inside flange of the second seal element.

Example 58. The assembly, system, device, apparatus, and method of any of the above Examples alone or in combination, wherein the outside diameter (OD) of the outer ring of the first bearing assembly is larger than an OD of the structural component.

Example 59. The assembly, system, device, apparatus, and method of any of the above Examples alone or in combination, wherein the outside diameter (OD) of the outer ring of the first bearing assembly is larger than an OD defined by an outside flange of the first seal element.

Example 60. The assembly, system, device, apparatus, and method of any of the above Examples alone or in combination, wherein the outside diameter (OD) of the outer ring of the first bearing assembly is larger than an OD defined by an outside flange of the second seal element.

Example 61. The assembly, system, device, apparatus, and method of any of the above Examples alone or in combination, wherein the can housing has one or more inlet ports and the outer ring of the first bearing assembly has one or more grooves on an exterior surface thereof.

Example 62. The assembly, system, device, apparatus, and method of any of the above Examples alone or in combination, wherein the equipment housing has one or more inlet ports and the outer ring of the second bearing assembly has one or more grooves on an exterior surface thereof.

Example 63. The assembly, system, device, apparatus, and method of any of the above Examples alone or in combination, wherein the equipment housing has one or more inlet ports for introducing flowable adhesive in a first state into a gap of a loose fitting bearing assembly.

Example 64. The assembly, system, device, apparatus, and method of any of the above Examples alone or in combination, wherein the structural component comprises a first structural component and a second structural component that contact one another along a seam.

Example 65. The assembly, system, device, apparatus, and method of any of the above Examples alone or in combination, wherein the can housing has a seam.

Example 66. The assembly, system, device, apparatus, and method of any of the above Examples alone or in combination, wherein the seam of the can housing is aligned with the seam located between the first structural component and the second structural component.

Example 67. The assembly, system, device, apparatus, and method of any of the above Examples alone or in combination, wherein the can housing comprises one or more inlet ports for introducing adhesive, and the equipment housing has at least one opening that aligns with one of the one or more inlet ports of the can housing.

Example 68. The assembly, system, device, apparatus, and method of any of the above Examples alone or in combination, wherein the can housing comprises a plurality of inlet ports for introducing adhesive, and the equipment housing has a same number of openings as the plurality of inlet ports.

Example 69. The assembly, system, device, apparatus, and method of any of the above Examples alone or in combination, wherein the outer ring of the second bearing assembly is in a loose fit arrangement with the equipment housing.

Example 70. The assembly, system, device, apparatus, and method of any of the above Examples alone or in combination, wherein the equipment housing comprises one or more ports for introducing flowable adhesive in a first state into a gap between the outer ring of the second bearing assembly and the equipment housing.

Example 71. The assembly, system, device, apparatus, and method of any of the above Examples alone or in combination, wherein the inner ring of the first bearing assembly comprises one or more grooves and the outer ring of the second bearing assembly comprises one or more grooves.

Example 72. The assembly, system, device, apparatus, and method of any of the above Examples alone or in combination, wherein the one or more grooves define holding spaces of adhesive.

Example 73. The assembly, system, device, apparatus, and method of any of the above Examples alone or in combination, wherein the shaft comprises one or more grooves.

Example 74. The assembly, system, device, apparatus, and method of any of the above Examples alone or in combination, wherein the equipment housing comprises one or more grooves.

Example 75. The assembly, system, device, apparatus, and method of any of the above Examples alone or in combination, wherein the inner ring of the bearing assembly is flat and without grooves.

Example 76. The assembly, system, device, apparatus, and method of any of the above Examples alone or in combination, wherein the outer ring of the bearing assembly is flat and without grooves.

Example 77. The assembly, system, device, apparatus, and method of any of the above Examples alone or in combination, wherein the can housing has no inlet ports and the outer ring of the bearing assembly is in a loose fitting arrangement with the bore.

Example 78. The assembly, system, device, apparatus, and method of any of the above Examples alone or in combination, wherein the can housing comprises one or more ports and the outer ring of the bearing assembly is aligned to the one or more ports on the can housing.

Example 79. The assembly, system, device, apparatus, and method of any of the above Examples alone or in combination, wherein the equipment housing comprises one or more ports and the outer ring of the bearing assembly is aligned to the one or more ports on the equipment housing.

1. A cartridge seal and bearing system comprising:
a can housing having a body having a wall with an interior surface defining a bore having a first end and a second end, the first end having a retaining wall or a retaining disc;
a structural component having a body located in the bore of the can housing;
a first seal element comprising an inside flange, an outside flange, and a center channel section located between the inside and outside flanges, the outside flange of the first seal element being pressed against the interior surface of the can housing by the structural component;
a second seal element comprising an inside flange, an outside flange, and a center channel section located between the inside and outside flanges, the outside flange of the second seal element being pressed against the interior surface of the can housing by the structural component;
a bearing assembly comprising an inner ring, an outer ring, and a plurality of rolling elements between the inner and outer rings, said bearing assembly located in the bore and closer to the second seal element than the first seal element;
wherein the outer ring is in a loose fit arrangement inside the bore when initially assembled or the inner ring is in a loose fit arrangement with a shaft when the shaft is inserted in through the inner ring; and
wherein the structural component has a flange stub, and wherein the flange stub is spaced from the interior surface of the can housing.

2. The cartridge seal and bearing system of claim 1, further comprising a first sealing washer, a second sealing washer spaced from the first sealing washer, and a second retaining wall or retaining disc located between the second sealing washer and the bearing element.

3. The cartridge seal and bearing system of claim 2, wherein the can housing with the body has a split line that separates the can housing into a first can housing component and a second can housing component.

4. The cartridge seal and bearing system of claim 1, wherein the structural component has a multi-piece body comprising a first structural component section and a second structural component section.

5. The cartridge seal and bearing system of claim 4, wherein the first structural component has a lip that mechanically engages with a lip on the outside flange of the first sealing element.

6. The cartridge seal and bearing system of claim 5, wherein the second structural component has a lip that mechanically engages with a lip on the outside flange of the second sealing element.

7. The cartridge seal and bearing system of claim 1, further comprising a canted coil spring biasing against the structural component and the inside flange of the first sealing element.

8. The cartridge seal and bearing system of claim 7, further comprising a second canted coil spring biasing against the structural component and the inside flange of the second sealing element.

9. The cartridge seal and bearing system of claim 1, wherein the plurality of rolling elements comprise a plurality of spherical balls.

10. The cartridge seal and bearing system of claim 1, wherein epoxy glue is located in a space between the outer ring and the interior surface of the can housing when in a first state, in which the epoxy glue is flowable.

11. The cartridge seal and bearing system of claim 10, wherein the epoxy glue has a second state in which the epoxy glue hardens and is not flowable.

12. The cartridge seal and bearing system of claim 11, wherein the bore of the can housing has a first bore section with a first inside diameter and a second bore section with a second inside diameter, which is larger than the first inside diameter.

13. The cartridge seal and bearing system of claim 11, wherein the bearing assembly is located in the second bore section.

14. The cartridge seal and bearing system of claim 1, further comprising a shaft projecting through the inner ring of the bearing assembly and a bore of the cartridge seal.

15. The cartridge seal and bearing system of claim 14, wherein the can housing and the shaft are located in an equipment housing.

16. The cartridge seal and bearing system of claim 15, wherein the bearing assembly is a first bearing assembly and wherein a second bearing assembly comprising an outer ring and an inner ring is located in the equipment housing and spaced from the can housing.

17. The cartridge seal and bearing system of claim 2, wherein the first sealing washer has a memory lip having a curved portion at the opening of the inside perimeter.

18. The cartridge seal and bearing system of claim 2, wherein both the outside perimeter of the first sealing washer and the outside perimeter of the second sealing washer contact the interior surface of the can housing.

19. The cartridge seal and bearing system of claim 1, wherein the bore has a generally constant inside diameter from the first end to the second end.

20. The cartridge seal and bearing system of claim 1, wherein the first seal element has an excluder and an annular recess at an end of the inside flange and an end of the center channel section.

21. The cartridge seal and bearing system of claim 20, wherein the second seal element has an excluder and an annular recess at an end of the inside flange and an end of the center channel section.

22. The cartridge seal and bearing system of claim 1, wherein the first seal element has a free end and the second seal element has a free end, and wherein the two free ends point at one another.

23. (canceled)

24. The cartridge seal and bearing system of claim 1, further comprising service grease located in a spring cavity defined by the first sealing element.

25. The cartridge seal and bearing system of claim 1, further comprising service grease located in a spring cavity defined by the second sealing element.

26. A method of assembling a pre-packaged cartridge and bearing system comprising:
providing a can housing having a body having a wall with an interior surface defining a bore having a first end and a second end, the first end having a retaining wall or a retaining disc;
placing a seal assembly inside the bore, the seal assembly comprising:
a structural component having a body located in the bore of the can housing;
a first seal element comprising an inside flange, an outside flange, and a center channel section located between the inside and outside flanges, the outside flange of the first seal element being pressed against the interior surface of the can housing by the structural component;
a second seal element comprising an inside flange, an outside flange, and a center channel section located between the inside and outside flanges, the outside flange of the second seal element being pressed against the interior surface of the can housing by the structural component;
placing a bearing assembly inside the bore, the bearing assembly comprising an inner ring, an outer ring, and a plurality of rolling elements between the inner and outer rings, said bearing assembly located in the bore and closer to the second seal element than the first seal element;
wherein the outer ring is in a loose fit arrangement inside the bore when initially assembled inside the bore or the inner ring is in a loose fit arrangement with a shaft when the shaft is inserted in through the inner ring; and
wherein the structural component has a flange stub, and wherein the flange stub is spaced from the interior surface of the can housing.

27. The method of claim 26, further comprising placing a shaft through the inner ring of the bearing assembly and a bore of the seal assembly.

28. The method of claim 27, further comprising adding epoxy glue through one or more ports located on the can housing.

29. The method of claim 28, further comprising curing the epoxy glue to fix the outer ring from moving.

30. The method of claim 29, further comprising placing the can housing inside an equipment housing and supporting the shaft with a second bearing assembly.

31. A cartridge seal and bearing system comprising:
a can housing having a body having a wall with an interior surface defining a bore having a first end and a second end, the first end having a retaining wall or a retaining disc;
a structural component having a body located in the bore of the can housing;
a first seal element comprising an inside flange, an outside flange, and a center channel section located between the inside and outside flanges, the outside flange of the first seal element being pressed against the interior surface of the can housing by the structural component;
a second seal element comprising an inside flange, an outside flange, and a center channel section located between the inside and outside flanges, the outside flange of the second seal element being pressed against the interior surface of the can housing by the structural component; and
wherein the structural component has a flange stub, and wherein the flange stub is spaced from the interior surface of the can housing.

32. The cartridge seal and bearing system of claim 31, further comprising a sealing waster located between the first seal element and the retaining wall or the retaining disc.

33. The cartridge seal and bearing system of claim 31, further comprising a bearing assembly comprising an inner ring, an outer ring, and a plurality of rolling elements between the inner and outer rings, said bearing assembly located in the bore and closer to the second seal element than the first seal element; and
wherein the outer ring is in a loose fit arrangement inside the bore when initially assembled or the inner ring is in a loose fit arrangement with a shaft when the shaft is inserted in through the inner ring.
